(19) United States
(12) Patent Application Publication
(10) Pub. No.: US 2021/0174457 A1
(43) Pub. Date: Jun. 10, 2021

(54) AUTOMATIC CLASSIFICATION OF DATA EXCHANGES BASED ON CUSTOMIZABLE CRITERIA

(71) Applicant: The Toronto-Dominion Bank, Toronto (CA)

(72) Inventor: Michael James Taggart, Ottawa (CA)

(73) Assignee: The Toronto-Dominion Bank, Toronto (CA)

(21) Appl. No.: 16/702,923

(22) Filed: Dec. 4, 2019

(51) Int. Cl. G06Q 40/00

(52) U.S. Cl. CPC G06Q 40/12

(57) ABSTRACT

The present disclosure involves systems, software, and computer implemented methods for categorizing data exchanges, based on a set of customizable criteria that has been customized by a third party. Each category to which the data transactions are assigned can be associated with a valuation return rate or earnings rate. Once each data exchange is assigned a category, an account associated with a user who is identified for the transaction can be credited a return based on the return rate associated with the category. In some embodiments, if no category exists that satisfies the customizable criteria, a new category can be generated.

### TECHNICAL FIELD

This disclosure generally relates to computer-implemented methods, software, and systems for automatically classifying data exchanges based on customizable criteria received from a third party entity.

### BACKGROUND

Credit account customers represent a significant customer segment for financial and lending institutions. In an effort to encourage usage of their products, many financial institutions and payment card providers can offer various rewards points and loyalty perk systems to reward customers for loyalty to and usage of their payment instruments.

### SUMMARY

The present disclosure involves systems, software, and computer implemented methods for categorizing data exchanges or transactions. A first example system includes a communications module, at least one memory storing instructions, a repository storing at least one set of default criteria and at least one set of customizable criteria for classifying data exchanges. The first example system further includes at least one hardware processor interoperably coupled with the at least one memory and the communications module. The instructions can cause the hardware processor to perform the following operations, including receiving a posting file that includes at least one data exchange and at least one data parameter associated with the data exchange. The instructions also can determine if each of the received data exchanges satisfies at least one set of customizable criteria stored in a memory and if a data exchange satisfies a set of customizable criteria, classify each of the data exchanges based on the at least one data parameter and the set of customizable criteria, assign each of the classified data exchanges to a particular category based on the classification, and credit an account associated with a user with a valuation return based on the assigned category.

Implementations can optionally include one or more of the following features.

In some instances, the data exchanges are financial transactions and the data exchange parameters include financial transaction parameters, including a value and at least one additional parameter. The at least one additional parameter can be a destination account type, a transaction date and time, and a customer status indicator.

In some instances, the set of customizable criteria includes criteria for classifying the data exchanges based on a vendor category, a vendor identity, a transaction amount threshold, a payment account type, recent payment account activity, or date and time of the transaction.

In some instances, the set of customizable criteria is associated with a merchant or financial institution and the merchant or financial institution are separate from the system processing the instructions.

In some instances, the system can be further configured to receive updated sets of customizable criteria and replace current sets of customizable criteria with the updated sets of customizable criteria.

In some instances, the system can be further configured to create a new category and associate the category with a particular valuation return when it is determined that a category that is associated with a set of customizable criteria does not exist.

In some instances, the data exchange, or financial transaction, is a credit card transaction.

In some instances, each category is associated with a sequence number, and a data exchange can satisfy multiple sets of customizable criteria associated with multiple categories. In these instances, a list of satisfying categories is created, and the data transaction is assigned to the category with the lowest sequence number.

In some instances, each category can have an associated budget, and if that budget is full, no further transaction can be assigned to that category. In these instances the category is removed from a list of categories that satisfy a particular data exchange, and the data exchange is reassigned to the category with the next lowest sequence number.

Similar operations and processes may be performed in a different system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. Additionally, similar operations can be associated with or provided as computer-implemented software embodied on tangible, non-transitory media that processes and transforms the respective data; some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 depicts a block diagram of a system for classifying data exchanges.

FIG. 2 depicts a general architecture for classifying data exchanges.

FIG. 3 is a swim-lane diagram describing an example method for classifying data exchanges from a financial institution, by a transaction processor, and with a loyalty system.

FIG. 4 is a flowchart describing a method for classifying data exchanges.

### DETAILED DESCRIPTION

This disclosure describes a system for categorizing data exchanges, such as financial transactions, based on a set of customizable criteria that has been customized by a third party, such as a financial institution or merchant system. Each category to which the financial transactions are assigned can be associated with a valuation return rate or earnings rate. Once each financial transaction is assigned a category, an account associated with a user who is identified for the transaction can be credited a return based on the return rate associated with the category. In some embodiments, if no category exists that satisfies the customizable criteria, a new category can be generated.

In some solutions, when a financial transaction is reported to a transaction processor, the transaction processor sends the transaction directly to a loyalty system, where operations of the loyalty system can determine a points return based on predetermined logic and information. In these instances, if a financial institution wants to initiate a new bonus program, it must request that the loyalty system perform all actions related to program generation, testing, and validating new logic, and before the loyalty system can correctly assign rewards or loyalty points to a transaction. Therefore, the bonus program cannot be implemented until the predetermined logic is generated, tested, and validated. In allowing financial institutions to perform transaction categorization prior to sending the transaction to the loyalty system, the solutions described herein increase flexibility and rapidity in which bonus programs can be implemented, while also providing significant additional control over how and when bonus programs are implemented, and allows financial institutions and merchants to define customizable criteria by which transactions are categorized without relying on the loyalty system's operations and delay.

By categorizing each transaction individually prior to processing a particular rewards return, including by using customizable criteria for particular types of transactions, a financial institution gains rapidity and flexibility in establishing and altering loyalty rewards programs. Additionally, because the customizable criteria can be tested and validated ahead of time or separately from other criteria, no lengthy test or validation period is required prior to initiating a bonus program with potentially complex criteria and rewards. The transaction processor can additionally have more robust routing logic than the loyalty processor. In this case, the present solution provides an increased number of factors that can be used to determine point earn.

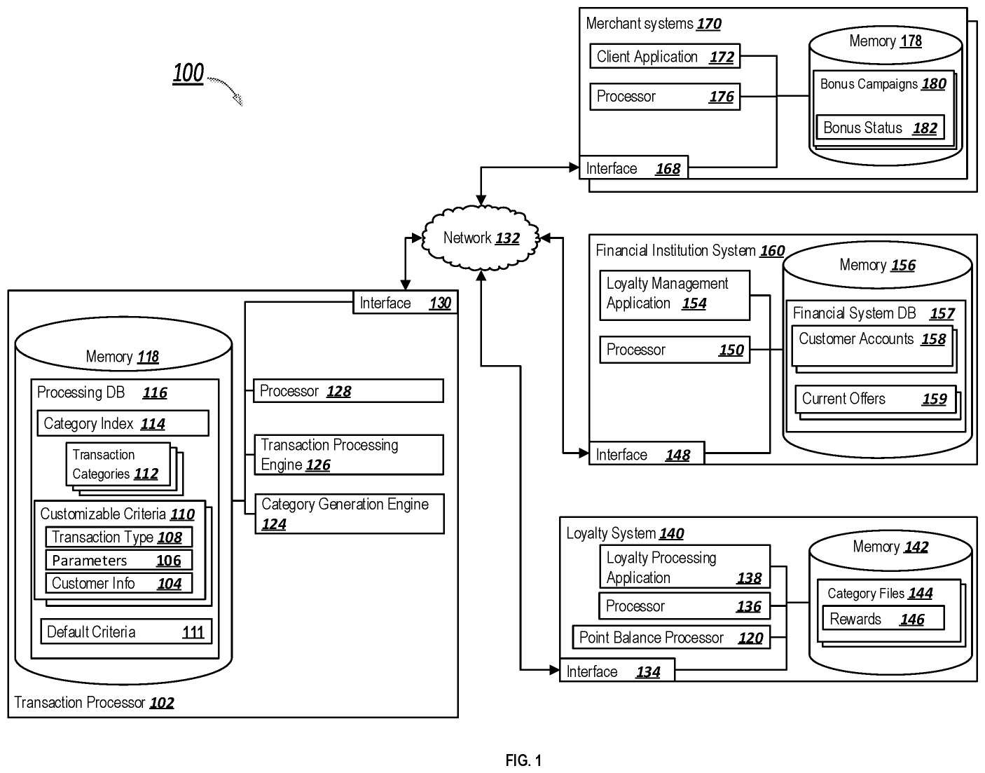

Turning to the illustrated example implementation, FIG. 1 is a block diagram illustrating an example system 100 for classifying data exchanges, such as financial transactions, and assigning the transactions to categories based on the classification. In general, the system 100 allows the illustrated components to share and communicate information across devices and systems (e.g., financial institution (FI) system 160, transaction processor 102, and one or more merchant systems 170, among others) via network 132. As described herein, the transaction processor 102 can be a cloud-based component or system (partially or fully), while in other instances, non-cloud systems can be used. In some instances, non-cloud-based systems, such as on-premise systems, client-server applications, and applications running on one or more client devices, as well as combinations thereof, can use or adapt the processes described herein. Although components are shown individually, in some implementations, functionality of two or more components, systems, or servers can be provided by a single component, system, or server.

As used in the present disclosure, the term “computer” is intended to encompass any suitable processing device. For example, transaction processor 102 and the FI system 160 can be any computer or processing device such as, for example, a blade server, general-purpose personal computer (PC), Mac® workstation, UNIX-based workstation, or any other suitable device. Moreover, although FIG. 1 illustrates a single transaction processor 102 and a single FI system 160, the transaction processor 102 and FI system 160 can be implemented using a single system or more than those illustrated, as well as computers other than servers, including a server pool. In another example, while the transaction processor 102 and the loyalty system 140 are depicted in FIG. 1 as separate systems, in some implementations, the loyalty system 140 may be incorporated in the same system as the transaction processor 102. In other words, the present disclosure contemplates computers other than general-purpose computers, as well as computers without conventional operating systems. Similarly, the merchant system 170 can be any system that can request data and/or interact with the transaction processor 102 or FI system 160. The merchant system 170, in some instances, can be a desktop system, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The merchant system 170 can include one or more specific applications executing on the merchant system 170, or the merchant system 170 can include one or more Web browsers or web applications that can interact with particular applications executing remotely from the merchant system 170, such as the client application 172.

The transaction processor 102 can be associated with the one or more applications or platforms, and can be associated with or a part of a cloud platform or system. As illustrated, the transaction processor 102 includes, or is associated with, interface 130, processor(s) 128, the transaction processing engine 126, the category generation engine 124, a processing database 116, and memory 118. While illustrated as provided by or included in the transaction processing system 102, some or all of the associated components can be separate or remote from the transaction processor 102. For example, while illustrated as a single system, the transaction processing engine 126 can be managed at a first system and/or application infrastructure, while the category generation engine 124 can be managed at a second system and/or application infrastructure. In some instances, various applications (e.g., the transaction processing engine 126) may be able to communicate and interact with each other through internal and/or external communications, including through one or more channels and protocols, one or more dedicated application programming interfaces (APIs), and/or other interfaces through which information needed for the application to execute is available. For purposes of the present illustration, these portions are illustrated together for ease of description.

Returning to the transaction processor 102 illustrated in FIG. 1, the interface 130 is used by the transaction processor 102 for communicating with other systems in a distributed environment—including within the system 100—connected to the network 132, including FI system 160, one or more merchant systems 170 associated with one or more merchants (not shown), and other systems communicably coupled to the transaction processor 102 and/or network 132. Generally, the interface 130 comprises logic encoded in software and/or hardware in a suitable combination and operable to communicate with the network 132 and other components. More specifically, the interface 130 can comprise software supporting one or more communication protocols associated with communications such that the network 132 and/or interface's hardware is operable to communicate physical signals within and outside of the illustrated system 100. Still further, the interface 130 can allow the transaction processor 102 to communicate with the FI system 160 and/or the loyalty system 140 and other systems, such as one or more merchant systems 170 to perform the operations described herein.

Network 132 facilitates wireless or wireline communications between the components of the system 100 (e.g., between the FI system 160, the merchant system(s) 170, or the transaction processor 102 etc.), as well as with any other local or remote computers, such as additional mobile devices, clients, servers, or other devices communicably coupled to network 132, including those not illustrated in FIG. 1. In the illustrated environment, the network 132 is depicted as a single network, but can be comprised of more than one network without departing from the scope of this disclosure, so long as at least a portion of the network 132 can facilitate communications between senders and recipients. In some instances, one or more of the illustrated components (e.g., the memory 118, the transaction processing engine 126, etc.) can be included within or deployed to network 132, or a portion thereof, as one or more cloud-based services or operations. The network 132 can be all or a portion of an enterprise or secured network, while in another instance, at least a portion of the network 132 can represent a connection to the Internet. In some instances, a portion of the network 132 can be a virtual private network (VPN). Further, all or a portion of the network 132 can comprise either a wireline or wireless link. Example wireless links can include 802.11a/b/g/n/ac, 802.20, WiMax, LTE, and/or any other appropriate wireless link. In other words, the network 132 encompasses any internal or external network, networks, sub-networks, or combination thereof operable to facilitate communications between various computing components inside and outside the illustrated system 100. The network 132 can communicate, for example, Internet Protocol (IP) packets, Frame Relay frames, Asynchronous Transfer Mode (ATM) cells, voice, video, data, and other suitable information between network addresses. The network 132 can also include one or more local area networks (LANs), radio access networks (RANs), metropolitan area networks (MANs), wide area networks (WANs), all or a portion of the Internet, and/or any other communication system or systems at one or more locations.

The transaction processor 102 also includes one or more processors 128. Although illustrated as a single processor 128 in FIG. 1, multiple processors can be used according to particular needs, desires, or particular implementations of the system 100. Each processor 128 can be a central processing unit (CPU), an application specific integrated circuit (ASIC), a field-programmable gate array (FPGA), or another suitable component. Generally, the processor 128 executes instructions and manipulates data to perform the operations of the transaction processor 102. Specifically, the processor 128 executes the algorithms and operations described in the illustrated figures, as well as the various software modules and functionality, including the functionality for sending communications to and receiving transmissions from the FI system 160, as well as to other devices and systems. Each processor 128 can have a single or multiple core, with each core available to host and execute an individual processing thread. Further, the number of, types of, and particular processors 128 used to execute the operations described herein can be dynamically determined based on a number of requests, interactions, and operations associated with the transaction processor 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including C, C++, JavaScript, Java™, Visual Basic, assembler, Peri®, any suitable version of 4GL, as well as others.

The transaction processor 102 can include, among other components, several applications, entities, programs, agents, or other software or similar components capable of performing the operations described herein. As illustrated, the transaction processor 102 includes, or is associated with, the transaction processing engine 126, and the category generation engine 124.

The transaction processing engine 126 can be any application, program, other component, or combination thereof that is associated with the transaction processor 102 and used to classify one or more transaction and assign it into a particular category. The transaction processing engine 126 can access or receive information from one or more transactional systems, or can be a part of those transactional systems, where information relating to various transactions is collected and information can be stored and/or referenced. In some instances, the transaction processing engine 126 can be a part of system executing, for example, a TSYS backend suite of applications managing one or more credit, debit, or other payment cards and accounts. The transaction processing engine 126 can, in some instances, receive information relating to one or more transactions, for example, in a posting file, and based on a set of rules or criteria determine a classification for each transaction.

The transaction processing engine 126 can, in some instances, be associated with or manage a processing database 116 or set of information, where the processing database 116 can store information associated with one or more transaction categories 112 and a category index 114. The category index 114 can comprise a list or summary of all available categories, and in some cases, additional details such as the category return rate for each category, or a number associated with each category, or other details. The transaction categories 112 are categories into which each transaction can be assigned. Each transaction category can be associated with a particular valuation return rate (e.g., 1%, 2%, 3%, etc.). In some implementations, the valuation return rate is assigned to each category by the loyalty system 140. For example, if a transaction is assigned to a category 112 that is associated with a 3% return, then an account of an individual who is identified for the transaction can be credited with 3% of the value of the transaction. In some implementations, the account of the individual can be credited with points or tokens associated with a value. In other implementations, the account can be credited directly with value. In some implementations, some transaction categories can be associated with a budget or an amount cap. In these implementations, each transaction assigned to the budgeted category can have a transaction amount that is cumulatively added until the budget is reached. Upon reaching the budget, the transaction processing engine 126 can prevent further transactions from being assigned to the budgeted category. In some implementations, the budget is a total and applies to all transactions in the category, including transactions from a plurality of users (e.g., one user could use 100% of the budget, or 50 users could each use 2% of the budget, but once the budget is spent, no further users may receive points associated with that category). In other implementations, the budget is per user and applies to each individual making transactions that are assigned to the budgeted category (e.g., each user can have $200 per month associated with a relatively highest earning category). Each transaction category can be associated with other parameters in addition to a points return and budget. For example, additional parameters can include fees, interest rates, grace periods, etc.

The transaction processing engine 126 can assign transactions received in a posting file (e.g., received from the FI system 160) to transaction categories 112 based on one or more sets of customizable criteria 110. The customizable criteria 110 can be defined by the FI system 160, by a merchant system 170, or other suitable entity. Customizable criteria 110 can be stored in the processing database 116 and used by the transaction processing engine 126 to assess one or more transactions in a posting file, and to subsequently assign the transactions to a transaction category 112 that satisfies the customizable criteria 110. The customizable criteria 110 can include criteria for determining if certain parameters are met in a particular transaction. For example, the customizable criteria 110 can include criteria related to a transaction type 108 (e.g., restaurant purchase, fuel purchase, etc.). The customizable criteria 110 can also include customer information 104, which can be criteria based on the individual or customer who initiated or executed the transaction. For example, the criteria for a transaction associated with a customer who is a platinum rewards member, may be different than the criteria for the same transaction associated with a silver rewards member. The customizable criteria 110 includes parameters 106 which can be, but are not limited to: a timestamp associated with the transaction, a vendor ID, a transaction amount, an account type, recent account activity, product purchased, account open date, etc. In some instances, the FI system 160 can generate and transmit new or updated customizable criteria 110 and transmit them to the transaction processor 102 via the network 132. The transaction processor 102 can update and maintain all active customizable criteria 110 in the processing database 116, such that any future transactions being processed are evaluated using the new or updated criteria 110.

In some instances, the processing database 116 stores default criteria 111. In the event the transaction processing engine 126 processes a transaction that does not satisfy any customizable criteria 110, the transaction processing engine 126 can utilize the default criteria 111 to classify the transaction. The default criteria 111 can be predetermined, static, and ensure that every transaction is successfully assigned to a transaction category 112.

After assigning a transaction to a transaction category 112, the transaction processing engine 126 can transmit a message to the loyalty system 140 which can then reward an individual associated with the transaction accordingly.

The category generation engine 124 can be, in some instances, associated with or communicably coupled with the processing database 116. The category generation engine 124 can manage the creation and maintenance of the transaction categories 112. In some instances, the category generation engine 124 analyzes any newly received customizable criteria 110 and determines if a transaction category 112 exists which satisfies the newly received customizable criteria 110. In the event there is not a transaction category 112 which satisfies the newly received customizable criteria, the category generation engine 124 can generate a new transaction category based on the newly received customizable criteria 110 and, in some cases, additional information. For example, if the FI system 160 decides to generate a new promotion that includes 3% cash back on any purchases made on weekends, a user at the FI system 160 can define a new set of customizable criteria, and transmit it, with a message requesting a particular sequence number or name to be associated with a newly generated category and return rate. When it is received at the transaction processor 102 the category generation engine 124 can generate a new transaction category 112 that satisfies the received criteria and associate it with the sequence number/name and return rate designated by the FI system 160.

Memory 118 of the transaction processor 102 can represent a single memory or multiple memories. The memory 118 can include any memory or database module and can take the form of volatile or non-volatile memory including, without limitation, magnetic media, optical media, random access memory (RAM), read-only memory (ROM), removable media, or any other suitable local or remote memory component. The memory 118 can store various objects or data, including financial data, user and/or account information, administrative settings, password information, caches, applications, backup data, repositories storing business and/or dynamic information, and any other appropriate information associated with the transaction processor 102, including any parameters, variables, algorithms, instructions, rules, constraints, or references thereto. Additionally, the memory 118 can store any other appropriate data, such as VPN applications, firmware logs and policies, firewall policies, a security or access log, print or other reporting files, as well as others. While illustrated within the transaction processor 102, memory 118 or any portion thereof, including some or all of the particular illustrated components, can be located, in some instances, remote from the transaction processor 102 in some instances, including as a cloud application or repository, or as a separate cloud application or repository when the transaction processor 102 itself is a cloud-based system. In some examples, the data stored in memory 118 can be accessible, for example, via network 132, and can be obtained by particular applications or functionality of the FI system 160. As illustrated and previously described, memory 118 includes the processing database 116, as well as instructions for executing the transaction processing engine 126, the category generation engine 124, the interface 130, and other applications and functionality.

In some implementations, a loyalty system 140 can manage and maintain the rewards each customer earns based on the transactions that have been categorized by the transaction processor 102. The loyalty system 140 can include a loyalty processing application 138, a point balance processor 120, a processor 136 (similar to or different from processor 128), and a memory 142 (similar to or different from memory 118).

The loyalty system 140 can receive and store category files 144 which can indicate which category particular transactions have been assigned. In some cases the category files 144 can include other information such as an individual associated with the transaction and a transaction amount. The loyalty processing application 138 can assess the transactions in the category files 144 and assign each transaction a reward 146 based on the transaction's assigned category. The loyalty system 140 can then credit an account associated with the transaction with the appropriate value or points associated with the reward 146. In some implementations, including that depicted in FIG. 1, the loyalty system 140 is separate from the transaction processor 102. In another implementation the components can be integral, (e.g., on the same computer using the same memory). In yet another implementation, the loyalty system 140 or a portion thereof may be a component or part of the FI system 160.

A point balance processor 120 can perform operations associated with crediting rewards 146 when points are determined, as well as debiting reward points when redemptions occur. In response to the transactions being assigned to a particular category, the point balance processor 120 can identify points to be awarded, and can credit a corresponding loyalty account of that customer. Similarly, when a reward is redeemed, in response to a customer selection and redemption without an offer, the point balance processor 120 can debit the rewards points accordingly. The point balance processor 120 can receive information from transaction processor 102, as well as from the FI system 160, among others, to review and process point-related actions and transactions, and to then credit or debit corresponding customer accounts 158.

As illustrated, one or more financial institution (FI) systems 160 can be present in the system 100. Each FI system 160 may be associated with a particular financial institution or group of financial institutions, and may include a financial system database 157 which can include one or more customer accounts 158 and one or more current offers 159. The FI system 160 can be associated with a portal through which a particular customer accesses their account information and can interact with one or more accounts or credit cards. As illustrated, the FI system 160 can include an interface 148 for communication (similar to or different from interface 130), at least one processor 150 (similar to or different from processor 128), a loyalty management application 154, and a memory 156 (similar to or different from memory 118).

The FI system 160 can include, among other components, several applications, entities, programs, agents, or other software or similar components capable of performing the operations described herein. The FI system 160 can be associated with a bank, a credit card issuer, or other financial institution. As illustrated, the FI system 160 includes, or is associated with the loyalty management application 154.

The loyalty management application 154 can be any application, program, other component, or combination thereof that is associated with a FI system 160 and is used to manage and store offer-related information and metrics. The loyalty management application 154 can access or receive information from one or more transactional systems, or can be a part of those transactional systems, where information relating to various user accounts is collected and information can be stored and/or referenced. In some instances, the loyalty management application 154 can be a part of system executing, for example, a TSYS backend suite of applications managing one or more credit, debit, or other payment cards and accounts. The loyalty management application 154 can, in some instances, allow a user at a financial institution to create, edit, modify, or remove new offers and associated customizable criteria. The loyalty management application 154 can transmit an update message to the transaction processors 102 with updated customizable criteria for a new or changed offer. For example, if a financial institution wants to provide a 3% bonus points offer for a specified time period, the loyalty management application 154 can be used to generate new customizable criteria for classifying transactions based on the new offer and transmit the new customizable criteria in a message to the transaction processor 102 (e.g., via the network 132). The loyalty management application 154 can also create and store the offer in the financial system database 157 as a current offer 159.

The illustrated FI system 160 is intended to encompass any computing device such as a desktop computer, laptop/notebook computer, mobile device, smartphone, personal data assistant (PDA), tablet computing device, one or more processors within these devices, or any other suitable processing device. In general, the FI system 160 and its components can be adapted to execute any operating system, including Linux, UNIX, Windows, Mac OS®, Java™, Android™, or iOS. In some instances, the FI system 160 can comprise a computer that includes an input device, such as a keypad, touch screen, or other device(s) that can interact with one or more third party applications, such as one or more dedicated mobile applications, including a loyalty application or other banking application. The FI system 160 can also interact with an output device that conveys information associated with the operation of the applications and their application windows to the user of the FI system 160. Such information can include digital data, visual information, or a graphical user interface (GUI). Specifically, the FI system 160 can be any computing device operable to communicate with the transaction processor 102, merchant systems 170, and/or other components via network 132, as well as with the network 132 itself, using a wireline or wireless connection. In general, FI system 160 comprises an electronic computer device operable to receive, transmit, process, and store any appropriate data associated with the system 100 of FIG. 1.

As illustrated, one or more merchant systems 170 can be present in the example system 100. Each merchant system 170 can be associated with a particular retailer or service provider, or may be a general system associated with a plurality of retailers and service providers. Each merchant system 170 can be associated with one or more bonus campaigns 180, where each bonus campaign 180 can be associated with a bonus status 182 or statuses (e.g., active, inactive, full, a percentage complete, etc.). As illustrated, a merchant system 170 can include an interface 168 for communication (similar to or different from interface 130), at least one processor 176 (similar to or different from processor 128), a client application 172, and a memory 178 (similar to or different from memory 118). The merchant system 170 can transmit details related to one or more bonus campaigns 180 to the FI system 160, which can develop or define the customizable criteria 110 based on the transmitted details.

One or more users can access the merchant system 170 via a client application 172 to make purchases or initiate transactions. The illustrated merchant system 170 is intended to encompass any computing device such as a desktop computer, laptop/notebook computer, mobile device, smartphone, personal data assistant (PDA), tablet computing device, one or more processors within these devices, or any other suitable processing device. In general, the merchant system 170 and its components can be adapted to execute any operating system, including Linux, UNIX, Windows, Mac OS®, Java™, Android™, or iOS. In some instances, the merchant system 170 can comprise a computer that includes an input device, such as a keypad, touch screen, or other device(s) that can interact with one or more third party applications, such as one or more dedicated mobile applications, including a loyalty application or other banking application. The merchant system 170 can also interact with an output device that conveys information associated with the operation of the applications and their application windows to the user of the merchant system 170. Such information can include digital data, visual information, or a GUI, as shown with respect to the merchant system 170. Specifically, the merchant system 170 can be any computing device operable to communicate with the FI system 160, other merchant systems 170, and/or other components via network 132, as well as with the network 132 itself, using a wireline or wireless connection. In general, merchant system 170 comprises an electronic computer device operable to receive, transmit, process, and store any appropriate data associated with the system 100 of FIG. 1.

While portions of the elements illustrated in FIG. 1 are shown as individual modules that implement the various features and functionality through various objects, methods, or other processes, the software can instead include a number of sub-modules, third-party services, components, libraries, and such, as appropriate. Conversely, the features and functionality of various components can be combined into single components as appropriate.

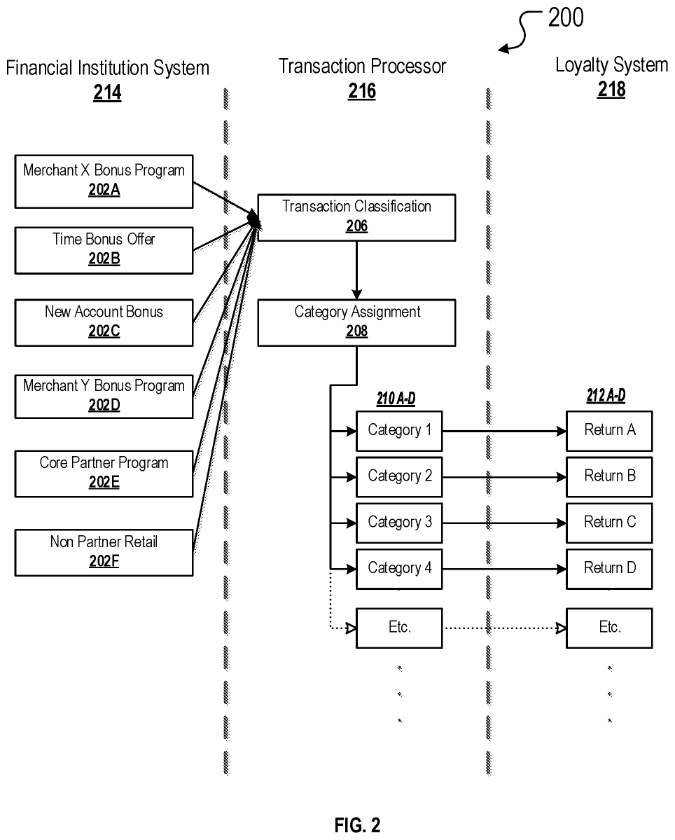

FIG. 2 depicts a general architecture for classifying data exchanges at a high level. In general, an FI system 214 can create or activate bonus programs as exemplified by elements 202A-F. Each program can have a set of customizable criteria that is sent to a transaction processor 216. The bonus programs depicted are shown as examples, and not intended to be all inclusive. The FI system 214 can create, remove, or modify bonus programs 202A-F as desired. When a bonus program is updated or modified it can transmit an updated or modified set of customizable criteria to the transaction processor 216.

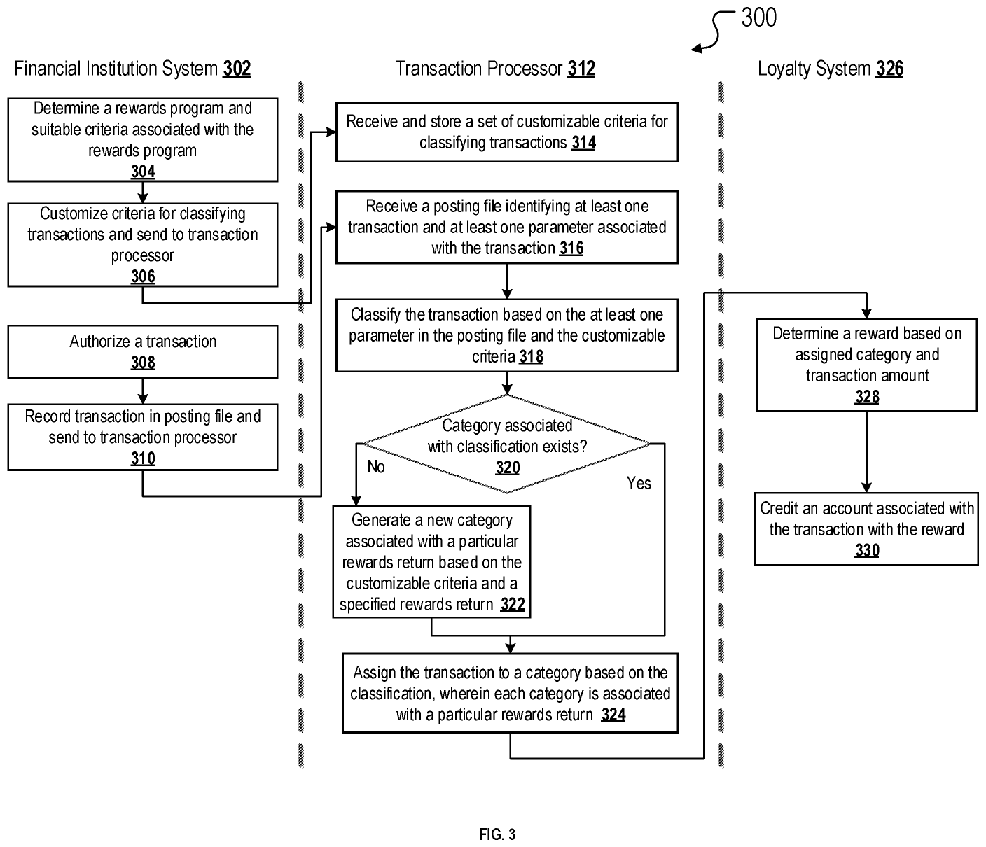

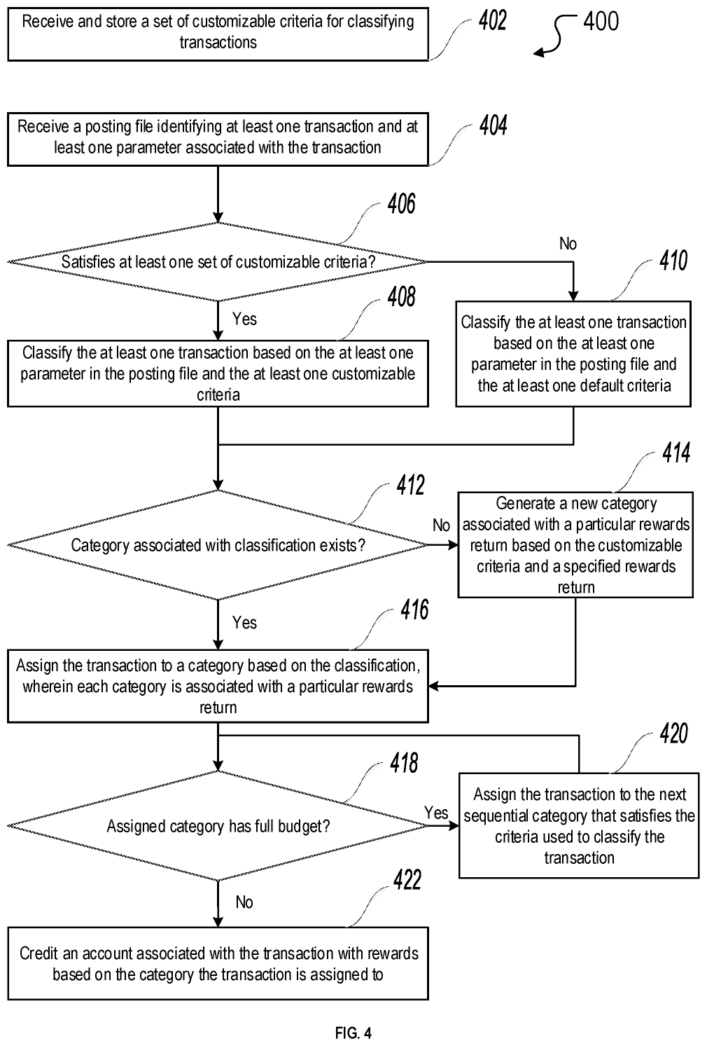

Upon receipt of customizable criteria from the FI system 214, the transaction processor 216 can classify each transaction (206). The classification can be based on the customizable criteria and additional information available in a posting file identifying one or more transactions. Transaction classification is discussed in further detail below with reference to FIGS. 3 and 4.

Once each transaction has been classified it can be assigned to a particular category among a plurality of categories (208). Each category (210 A-D) is associated with a particular return rate and configured such that a loyalty system 218 can identify transactions that are assigned to a particular category.

The loyalty system 218 can then credit a return to an account associated with each transaction, based on the category that transaction has been assigned to (212A-D), and based on the information associated with the transaction itself, including the amount of a particular purchase or transaction.

FIG. 3 depicts a swim-lane diagram describing an example method for classifying data exchanges from a financial institution, by a transaction processor, and with a loyalty system. In some implementations, the financial institution (FI) system 302 is similar to the financial institution system 160 as described with reference to FIG. 1.

At 304, the financial institution system 302 can identify a bonus program, based on user input or received bonus program details from a merchant system (e.g., the merchant system 170 of FIG. 1) and select suitable criteria associated with the bonus program for classifying transactions. The criteria can be any suitable criteria, including combinations of criteria, which can include, for example, timestamps associated with the transaction, a vendor ID, a transaction amount, an account type, recent account activity, product purchased, account open date, etc. In some implementations, options for determining the criteria are provided by the transaction processor 312, and can be defined or set by a user or administrator at or associated with the FI system 302. Once a bonus program and suitable criteria have been determined, the FI system 302 can then create or define a set of customizable criteria that will determine if a particular transaction qualifies for the bonus program. The FI system 302 can then transmit the customized criteria to the transaction processor 312 as a set of customizable criteria.

At 314, the transaction processor 312 receives the set of customizable criteria and stores it in a repository. The customizable criteria can then be used to classify transactions as new transactions are received, or as prior transactions are processed.

Returning to 308, when a customer of the financial institution makes a purchase, the financial institution authorizes the transaction. Upon successful authorization, funds are credited to a vendor and the transaction is recorded with relevant information. Relevant information can include, for example, a transaction amount, date and time, destination account, merchant information, currency, terminal information, etc.

At 310, the FI system 302 generates a posting file that includes the transaction details for a plurality of transactions. The posting file can include, for example, each transaction from a particular account in the last 24 hours. In another example, the posting file can include all transactions for a specific region in the past 20 minutes. In other instances, transactions can be provided by the FI system 302 in another format, or in a streaming manner, where the alternative format allows the transaction processor 312 to identify and parse the transactions along with any relevant details or other information.

At 316, the posting file is sent from the FI system 302 and received by the transaction processor 312. The posting file can include relevant parameters associated with one or more transactions. For example a transaction amount, date and time, destination account, merchant information, currency, terminal information, etc. The transaction processor 312 can then parse the posting file to analyze individual transactions.

At 318, the transaction processor 312 classifies each transaction in the posting file based on the customizable criteria and at least one parameter in the posting file. For example, one particular customizable criteria may indicate that transactions greater than $100.00 with a specific vendor and on a specific date (or in a particular date range) should earn 5% points based on the amount transacted. In this example, the transaction processor 312 can identify, from the posting file, a transaction of $112.20 that was paid to the specific vendor on the specific day or during the specific range, and can classify the transaction as satisfying the particular customizable criteria.

In some instances, a transaction may not satisfy any set of customizable criteria. In these instances, a default set of criteria can be predetermined and stored by the transaction processor 312, and the transaction processor 312 can classify the transaction based on the default criteria.

The transaction processor 312 can then determine if a category associated with the classified transaction exists at 320. If a category does exist, the transaction processor can proceed to 324, if one does not exist, then the transaction processor proceeds to 322.

At 322, if the transaction processor 312 determines that no category exists for assigning transactions which satisfy a particular set of customizable criteria, then the transaction processor 312 can generate a new category based on the particular set of customizable criteria and a specified rewards return. In one implementation, new categories can be generated automatically by a computer system and based on predetermined criteria as well as the customizable criteria. In another implementation, new categories can be manually defined by, for example, a system administrator.

The classified transaction is then assigned to a category at 324. Each category is associated with a particular rewards return, such that transactions assigned to that category can be rewarded based on the return. In some implementations, categories can be associated with additional parameters, such as a budget or maximum expenditure limit. For example, a category associated with a 4% rewards return from a particular vendor may have an authorized total budget of $1 million for all users. Once $1 million worth of transactions have been assigned to this category from all users, no further transactions may be assigned to it. In another implementation, the category can have a budget per customer, so that each customer can spend up to a maximum amount before they no longer qualify for the rewards at that particular level. In some implementations, additional parameters can be, for example, a priority rating which ensures it is analyzed in the appropriate sequence when compared to other categories, or a sequence number for ease of indexing, among other suitable parameters.

In some instances, the classified transaction may satisfy more than one set of customizable criteria. In these instances, the transaction processor 312 can assign the classified transaction to a category by prioritizing categories with higher return rates or as otherwise defined. In another implementation, the transaction processor 312 can use prioritization information associated with each category to assign the classified transaction. In yet another implementation, the transaction processor 312 can individually assess whether to assign a particular transaction to each category based on a sequence number, and assign the transaction to the category with the relatively lowest sequence number that satisfies the customizable criteria.

Once each transaction has been assigned a category, the assigned transactions can be transmitted to a loyalty system 326 to determine a reward to credit the customer (328). The reward can be loyalty points, cash back, credit to a debt, or any other suitable reward. The loyalty system 326 can determine, for each transaction, the reward return rate associated with the assigned category and the reward based on the category's specific rate and the transaction amount.

Once a reward has been determined, the loyalty system 326 can credit a loyalty account associated with the transaction with the reward (330). For example, if a customer makes a purchase using a credit card that qualifies for a reward, the loyalty system 326 can reward that credit account, or a loyalty or rewards account corresponding to the credit account, with points based on the reward.

FIG. 4 is a flow diagram of an example method 400 for classifying data exchanges. FIG. 4 is an example method illustrated from the point of view of a transaction processor, such as transaction processor 102 of FIG. 1. However, it will be understood that method 400 may be performed, for example, by any other suitable system, environment, software, and hardware, or a combination of systems, environments, software, and hardware as appropriate. In some instances, method 400 can be performed by the transaction processor 102, or portions thereof, described in FIG. 1, as well as other components or functionality described in other portions of this description. In other instances, method 400 may be performed by a plurality of connected components or systems. Any suitable system(s), architecture(s), or application(s) can be used to perform the illustrated operations.

In one instance, method 400 describes a method performed within a transaction processor which includes a communications module, at least one memory, and at least one hardware processor interoperably coupled with the at least one memory and the communications module. The at least one memory can include a repository storing at least one set of default criteria and at least one set of customizable criteria for classifying data exchanges. The memory may also store instructions that instruct the at least one hardware processor to perform particular operations.

At 402, a set of customizable criteria for classifying data exchanges (e.g., transactions) is received and stored in a repository. The customizable criteria can include parameters which can be, but are not limited to: a timestamp associated with the transaction, a vendor ID, a transaction amount, an account type, recent account activity, product purchased, account open date, etc. In some implementations, the set of customizable criteria is received and stored in advance (e.g., one day before, one hour before, etc.) of receiving transactions to process. In another implementation, additional sets of customizable criteria, or updated set of customizable criteria, can be received after processing at least some transactions.

At 404, a posting file or other suitable message, is received which identifies at least one transaction and at least one parameter associated with the transaction. The message can include relevant parameters associated with one or more transactions. For example a transaction amount, date and time, destination account, merchant information, currency, terminal information, etc. Each transaction can include or be associated with, at least some of the following: a date and time of the transaction, an amount of the transaction, one or more accounts associated with the transaction, a category of purchase or merchant associated with the transaction, and/or any other suitable criteria that may be used to classify the transaction.

At 406, a determination is made whether a set of customizable criteria is satisfied for each transaction in the posting file. If it is determined that at least one set of customizable criteria is satisfied, then method 400 proceeds to 408.

At 408, the transaction processor classifies each transaction in the posting file based on the at least one parameter in the posting file as evaluated using the at least one set of criteria. In some instances, a transaction may satisfy a single set of customizable criteria. In another instance, a transaction can satisfy more than one set of customizable criteria. By classifying each transaction at the transaction processor, the transactions can be assigned to categories prior to being transmitted to a loyalty system. This early classification simplifies computations required by the loyalty system, and increases flexibility for classification criteria at the financial institution.

Returning to 406, if it is determined that a particular transaction does not satisfy any set of customizable criteria, then method 400 proceeds to 410, and the particular transaction is classified using at least one set of default criteria stored in the repository and the at least one parameter in the posting file. In some implementations, the default criteria will always lead to a transaction being assigned to a default category. In some implementations, the default category can be processed by a loyalty system remotely.

Following classification, at 412 it is determined whether or not a category associated with the classification of the transaction exists. If it is determined that a category associated with the classification exists, method 400 proceeds to 416; alternatively, method 400 proceeds to 414.

At 414, a new category is generated based on the classification, the set of customizable criteria, and a specified rewards return. In one implementation, new categories can be generated automatically by a computer system and based on predetermined criteria as well as the customizable criteria. In another implementation, new categories can be manually defined by, for example, a system administrator.

Returning to 412, if it is determined that an associated category exists, method 400 proceeds to 416. At 416, the transactions are assigned to the category based on their classification. Each category is associated with at least a reward return, and in some instances, additional information or parameters, for example, a budget or maximum expenditure limit, a priority rating which ensures it is analyzed in the appropriate sequence when compared to other categories, or a sequence number for ease of indexing, among other suitable parameters. In the instances where a transaction satisfies more than one set of customizable criteria, the transaction can be assigned based on prioritizing categories with higher return rates. In another implementation, the transaction processor can use prioritization information (e.g., the priority rating) associated with each category to assign the classified transaction. In yet another implementation, the transaction processor can assess each category based on a sequence number and can assign the transaction to the category with the relatively lowest sequence number that satisfies the customizable criteria. In this implementation, each category may be evaluated sequentially, so that lower sequence numbers are evaluated first, and such that the evaluations end once a particular criteria is met.

At 418, after assignment to a category, it is determined whether the assigned category has a full budget. If the assigned category's budget is full and does not allow additional transactions to be assigned to it, method 400 proceeds to 420; otherwise, method 400 proceeds to 422.

At 420, the transaction is assigned to the category with the next relatively lowest sequence number (or the next category based on priority, etc.) whose criteria is satisfied by the transaction. If no other criteria are satisfied, the transaction can be assigned to a default category. Otherwise, a new assignment to another category associated with a satisfied set of customizable criteria is made. Following this new assignment, method 400 returns to 418.

At 422, a loyalty or reward account associated with each transaction and the corresponding user is credited with rewards based on the category to which each transaction is assigned. For example, if a customer makes a purchase using a credit card that qualifies for a reward, a loyalty or reward account associated with that customer can be credited with points based on the reward.

The preceding figures and accompanying description illustrate example processes and computer-implementable techniques. However, system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, the described systems and flows may use processes and/or components with or perform additional operations, fewer operations, and/or different operations, so long as the methods and systems remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. A system for classifying financial transactions, the system comprising:
a communications module;
at least one memory storing instructions, at least one set of customizable criteria, and at least one set of default criteria for classifying financial transactions into one of a plurality of categories;
at least one hardware processor interoperably coupled with the at least one memory and the communications module, wherein the instructions instruct the at least one hardware processor to:
receive a posting file associated with at least one financial transaction, the posting file identifying an entity and at least one financial transaction parameter associated with each financial transaction;
determine, automatically, if each financial transaction satisfies at least one set of the at least one set of customizable criteria;
in response to determining that at least one financial transaction satisfies one set of customizable criteria, automatically:
classify each financial transaction based on the at least one financial transaction parameter and the at least one set of customizable criteria;
assign each financial transaction to a particular category based on its respective classification, wherein each category corresponds to a particular valuation return rate, and wherein each category is associated with a sequence number; and
credit, for each financial transaction, an account associated with the entity identified with the particular financial transaction with a valuation return based on the particular valuation return rate corresponding to the particular category to which the financial transaction is assigned;
in response to determining that at least one financial transaction satisfies more than one set of customizable criteria associated with more than one category of the plurality of categories, automatically:
classify each financial transaction based on the at least one financial transaction parameter and the at least one set of customizable criteria;
determine a list of categories a particular classified financial transaction satisfies;
assign the particular classified financial transaction to the category on the list of categories associated with the relatively lowest sequence number; and
credit, for the particular classified financial transaction, the account associated with the entity identified with the particular financial transaction with the valuation return associated with the particular valuation return rate corresponding to the particular category to which the financial transaction is assigned.

2. The system of claim 1, wherein the financial transaction parameters include a value and at least one additional financial transaction parameter.

3. The system of claim 2, wherein the at least one additional financial transaction parameter comprises:
a destination account type;
a transaction date and time; and
a customer status indicator.

4. The system of claim 1, wherein the set of customizable criteria comprises criteria for classifying financial transactions based on:
a vendor category;
a vendor identity;
a transaction amount threshold;
a payment account type;
recent payment account activity; or date and time of the transaction.

5. The system of claim 1, wherein the at least one set of customizable criteria is associated with a merchant or a financial institution, and wherein the merchant or financial institution are separate from the system.

6. The system of claim 1 further comprising:
receiving an updated set of customizable criteria; and
replacing at least one set of customizable criteria with the updated set of customizable criteria for future classifications.

7. The system of claim 1, wherein assigning a financial transaction to a category further comprises, in response to determining that a category associated with the classification of the financial transaction does not exist:
create a new category and associate the category with a particular valuation return.

8. The system of claim 2, wherein the financial transaction includes a purchase with a credit card.

9. (canceled)

10. The system of claim 1, wherein assigning each financial transaction to a category further comprises:
determining if a budget associated with the assigned category is full; and
in response to determining the assigned category has a full budget:
removing the assigned category from the list of categories; and
reassigning the particular classified financial transaction to the category on the list of categories associated with the lowest sequence number.

11. The system of claim 1, wherein the memory stores at least one set of default criteria, and wherein in response to determining that at least one financial transaction does not satisfy at least one set of customizable criteria:
assign each data exchange that does not satisfy at least one set of customizable criteria to a default category.

12. A non-transitory, computer-readable medium storing computer-readable instructions executable by a computer and configured to:
receive a posting file associated with at least one financial transaction, the posting file identifying an entity and at least one financial transaction parameter associated with each data exchange;
determine, automatically, if each financial transaction satisfies at least one set of customizable criteria;
in response to determining that at least one financial transaction satisfies one set of the at least one set of customizable criteria, automatically:
classify each financial transaction based on the at least one financial transaction parameter and at least one set of customizable criteria;
assign each financial transaction to a particular category among a plurality of categories based on its respective classification, wherein each category corresponds to a particular valuation return rate, and wherein each category is associated with a sequence number; and
credit, for each financial transaction, an account associated with the entity identified with the particular financial transaction with a valuation return based on the particular valuation return rate corresponding to the particular category to which the financial transaction is assigned;
in response to determining that at least one financial transaction satisfies more than one set of customizable criteria associated with more than one category of the plurality of categories, automatically:
classify each financial transaction based on the at least one financial transaction parameter and the at least one set of customizable criteria;
determine a list of categories a particular classified financial transaction satisfies;
assign the particular classified financial transaction to the category on the list of categories associated with the relatively lowest sequence number; and
credit, for the particular classified financial transaction, the account associated with the entity identified with the particular financial transaction with the valuation return associated with the particular valuation return rate corresponding to the particular category to which the financial transaction is assigned.

13. The non-transitory, computer-readable medium of claim 12, wherein the financial transaction parameters include a value and at least one additional financial transaction parameter.

14. The non-transitory, computer-readable medium of claim 13, wherein the at least one additional financial transaction parameter comprises:
a destination account type;
a transaction date and time; and
a customer status indicator.

15. The non-transitory, computer-readable medium of claim 12, wherein the set of customizable criteria comprises criteria for classifying financial transactions based on:
a vendor category;
a vendor identity;
a transaction amount threshold;
a payment account type;
recent payment account activity; or date and time of the transaction.

16. The non-transitory, computer-readable medium of claim 12, wherein the set of customizable criteria are associated with a merchant or a financial institution, and wherein the merchant or financial institution are separate from a system executing the computer-readable medium.

17. The non-transitory, computer-readable medium of claim 12, further comprising:
receiving an updated set of customizable criteria; and
replacing at least one set of customizable criteria with the updated set of customizable criteria for future classifications.

18. The non-transitory, computer-readable medium of claim 12, wherein assigning a financial transaction to a category further comprises, in response to determining that a category associated with the classification of the financial transaction does not exist:
create a new category and associate the category with a particular valuation return.

19. A computerized method performed by one or more processors for classifying financial transactions, the method comprising:
receiving a posting file associated with at least one financial transaction, the posting file identifying an entity and at least one financial transaction parameter associated with each data exchange;
determining, automatically, if each financial transaction satisfies at least one set of customizable criteria;
in response to determining that at least one financial transaction satisfies one set of customizable criteria, automatically:
classifying each financial transaction based on the at least one financial transaction parameter and at least one set of customizable criteria;
assigning each financial transaction to a particular category among a plurality of categories based on its respective classification, wherein each category corresponds to a particular valuation return rate, and wherein each category is associated with a sequence number; and
crediting, for each financial transaction, an account associated with the entity identified with the particular financial transaction with a valuation return based on the particular valuation return rate corresponding to the particular category to which the financial transaction is assigned;
in response to determining that at least one financial transaction satisfies more than one set of customizable criteria associated with more than one category of the plurality of categories, automatically:
classifying each financial transaction based on the at least one financial transaction parameter and the at least one set of customizable criteria;
determining a list of categories a particular classified financial transaction satisfies;
assigning the particular classified financial transaction to the category on the list of categories associated with the relatively lowest sequence number; and
credit, for the particular classified financial transaction, the account associated with the entity identified with the particular financial transaction with the valuation return associated with the particular valuation return rate corresponding to the particular category to which the financial transaction is assigned.

20. The method of claim 19, wherein the wherein the financial transaction parameters include a value and at least one additional financial transaction parameter.
